(19) United States
(12) Patent Application Publication
(10) Pub. No.: US 2025/0335714 A1
(43) Pub. Date: Oct. 30, 2025

(54) SENTENCE GENERATION

(71) Applicant: Tencent Technology (Shenzhen) Company Limited, Shenzhen (CN)

(72) Inventor: Di LU, Shenzhen (CN)

(73) Assignee: Tencent Technology (Shenzhen) Company Limited, Shenzhen (CN)

(21) Appl. No.: 19/261,837

(22) Filed: Jul. 7, 2025

Related U.S. Application Data
(63) Continuation of application No. PCT/CN2024/093001, filed on May 14, 2024.

(30) Foreign Application Priority Data
May 17, 2023 (CN) 202310560218.1

(51) Int. Cl. G06F 40/30; G06F 40/242; G06F 40/289

(52) U.S. Cl. CPC G06F 40/30; G06F 40/242; G06F 40/289

(57) ABSTRACT

A sentence generation method is provided. In the sentence generation method, a first sentence representation vector of a first sentence is encoded to obtain a first semantic representation vector and a perturbation weight vector. The first sentence representation vector is determined based on a character vector of each respective character in the first sentence. The first semantic representation vector indicates a plurality of semantics of the first sentence. The perturbation weight vector is configured to control a perturbation of the first semantic representation vector by a pre-determined perturbation vector. The first semantic representation vector is perturbed based on the perturbation weight vector and the perturbation vector, to obtain a second semantic representation vector. The second semantic representation vector is decoded to obtain a second sentence. Apparatus and non-transitory computer-readable storage medium counterpart aspects are also contemplated.

### RELATED APPLICATIONS

The present application is a continuation of International Application No. PCT/CN2024/093001, filed on May 14, 2024, which claims priority to Chinese Patent Application No. 202310560218.1, filed on May 17, 2023. The entire disclosures of the prior applications are hereby incorporated by reference.

### FIELD OF THE TECHNOLOGY

This disclosure relates to the field of computer technologies, including to a sentence generation method and apparatus, a storage medium, and an electronic device.

### BACKGROUND OF THE DISCLOSURE

During processing of a natural language task, robustness of a task processing model is usually evaluated by using a textual adversarial attack method. A basic implementation process of the textual adversarial attack method includes: a human-imperceptible perturbation is added to a text data sample to cause incorrect prediction of a model, and robustness of the model is tested and/or the model is improved.

Textual adversarial attacks are classified into three attack manners: a character-level attack, a word-level attack, and a sentence-level attack. During implementation of the three types of text attack methods, generation of an adversarial attack sample plays a vital role.

In the related art, a method for generating a character-level adversarial attack sample and a method for generating a word-level adversarial attack sample are provided. According to the method for generating character-level adversarial attack text, importance of each character in a sentence is calculated, the descending order of the importance of the characters is taken as an attack order, and the perturbation is added by replacing a character with a homophone or a character with a similar form, adding/deleting a character, or the like. According to the method for generating a word-level adversarial attack sample, importance of each word in a sentence is calculated, the descending order of the importance of the words is taken as an attack order, and an adversarial attack sample is generated by synonym or near-synonym replacement. However, most current textual adversarial attacks are performed at the character level or the word level. There is no effective solution for generating a sentence-level adversarial attack sample (adversarial attack text) and implementing a sentence-level text attack method.

### SUMMARY

Aspects of this disclosure provide a sentence generation method and apparatus, a storage medium, and an electronic device.

In an aspect of this disclosure, a sentence generation method is provided. In the sentence generation method, a first sentence representation vector of a first sentence is encoded to obtain a first semantic representation vector and a perturbation weight vector. The first sentence representation vector is determined based on a character vector of each respective character in the first sentence. The first semantic representation vector indicates a plurality of semantics of the first sentence. The perturbation weight vector is configured to control a perturbation of the first semantic representation vector by a pre-determined perturbation vector. The first semantic representation vector is perturbed based on the perturbation weight vector and the perturbation vector, to obtain a second semantic representation vector. The second semantic representation vector is decoded to obtain a second sentence.

In an aspect of this disclosure, a sentence generation system, including processing circuitry, is provided. The processing circuitry is configured to encode a first sentence representation vector of a first sentence to obtain a first semantic representation vector and a perturbation weight vector. The first sentence representation vector is determined based on a character vector of each respective character in the first sentence. The first semantic representation vector indicate a plurality of semantics of the first sentence. The perturbation weight vector is configured to control a perturbation of the first semantic representation vector by a pre-determined perturbation vector. The processing circuitry is configured to perturb the first semantic representation vector, based on the perturbation weight vector and the perturbation vector, to obtain a second semantic representation vector. The processing circuitry is configured to decode the second semantic representation vector to obtain a second sentence.

According to another aspect of the present disclosure, a non-transitory computer-readable storage medium is disclosed. The non-transitory computer-readable storage medium stores instructions which, when executed by at least one processor, cause the at least one processor to perform the sentence generation method.

The aspects of this disclosure provide a sentence generation method, which includes: encoding a first sentence representation vector of a first sentence, to obtain a first semantic representation vector and a perturbation weight vector, the first sentence representation vector being a vector determined based on a character vector of each character in the first sentence, the first semantic representation vector indicating semantics of the first sentence, and the perturbation weight vector being configured to control a perturbation of the first semantic representation vector by a pre-determined perturbation vector; perturbing the first semantic representation vector based on the perturbation weight vector and the perturbation vector, to obtain a second semantic representation vector; and decoding the second semantic representation vector, to obtain a second sentence, the first sentence and the second sentence having same or similar semantics.

The aspects of this disclosure further provide a sentence generation apparatus, which includes: an encoding unit, configured to encode a first sentence representation vector of a first sentence, to obtain a first semantic representation vector and a perturbation weight vector, the first sentence representation vector being a vector determined based on a character vector of each character in the first sentence, the first semantic representation vector indicating semantics of the first sentence, and the perturbation weight vector being configured to control a perturbation of the first semantic representation vector by a pre-determined perturbation vector; a first processing unit, configured to perturb the first semantic representation vector based on the perturbation weight vector and the perturbation vector, to obtain a second semantic representation vector; and a decoding unit, configured to decode the second semantic representation vector, to obtain a second sentence, the first sentence and the second sentence having same or similar semantics.

The aspects of this disclosure further provide a non-transitory computer-readable storage medium, which has a computer program stored therein. The computer program is configured to, when run, perform the foregoing sentence generation method.

The aspects of this disclosure further provide a computer program product, which includes a computer program/instructions. A processor executes the computer program/instructions, to implement the operations of the foregoing method.

The aspects of this disclosure further provide an electronic device, which include a memory and a processor. The memory has a computer program stored therein, and the processor is configured to execute the computer program to perform the foregoing sentence generation method.

According to the foregoing aspects provided in this disclosure, the first semantic representation vector of the first sentence is perturbed based on the perturbation weight vector and the perturbation vector, to obtain the second semantic representation vector; and then, the second semantic representation vector is decoded, to obtain the second sentence having semantics the same as or similar to that of the first sentence, and the second sentence is taken as a sentence-level adversarial attack sample. A degree of perturbation may be set according to the perturbation weight vector, to control a semantic distance between the second semantic representation vector and the first semantic representation vector. In this way, the semantic distance between the generated sentence-level adversarial attack sample and the original input sample is controllable. This aligns with a fundamental objective of generating an adversarial attack sample. That is, perturbation is performed on a sentence level in a case that the semantics of the adversarial attack sample is similar to that of the original sample, to obtain a corresponding sample with similar semantics/intention. By the method, validity of the generated adversarial attack sample can be improved. In addition, perturbation information of different degrees of perturbation may be added to the original input sample by adjusting the perturbation weight vector, which increases diversity of a hidden layer representation of the original input sample, and improves diversity of the generated adversarial attack sample. In addition, robustness of a task processing model is evaluated by using a sentence-level text attack method, which improves the robustness of the task processing model.

### BRIEF DESCRIPTION OF THE DRAWINGS

The accompanying drawings described herein are used to provide a further understanding of this disclosure, and form part of this disclosure. Examples of aspects of this disclosure and descriptions thereof are used to explain this disclosure.

FIG. 1 is a schematic diagram of an application scenario of a sentence generation method according to an aspect of this disclosure.

FIG. 2 is a flowchart of a sentence generation method according to an aspect of this disclosure.

FIG. 3 is a schematic diagram of another application scenario of a sentence generation method according to an aspect of this disclosure.

FIG. 4 is a schematic diagram of still another application scenario of a sentence generation method according to an aspect of this disclosure.

FIG. 5 is an overall schematic diagram of a sentence generation method according to an aspect of this disclosure.

FIG. 6 is another overall schematic diagram of a sentence generation method according to an aspect of this disclosure.

FIG. 7 is a schematic diagram of a specific example of a sentence generation method according to an aspect of this disclosure.

FIG. 8 is a schematic structural diagram of an encoder according to an aspect of this disclosure.

FIG. 9 is a schematic structural diagram of a decoder according to an aspect of this disclosure.

FIG. 10 is a diagram of a result obtained after normalizing an output of a last layer of decoder according to an aspect of this disclosure.

FIG. 11 is a schematic diagram of an implementation process of a beam search algorithm according to an aspect of this disclosure.

FIG. 12 is a schematic structural diagram of a sentence generation apparatus according to an aspect of this disclosure.

FIG. 13 is a schematic structural diagram of an electronic device according to an aspect of this disclosure.

### DETAILED DESCRIPTION

The following describes technical solutions in aspects of this disclosure with reference to the accompanying drawings.

The descriptions of the terms are provided as examples only and are not intended to limit the scope of the disclosure.

Terms “first”, “second”, and the like in the description, the claims, and the drawings of this disclosure are intended to distinguish between similar objects, but are not necessarily used to describe a specific order or sequence. Such used data is interchangeable where appropriate, whereby the aspects of this disclosure described here can be implemented in an order other than those illustrated or described here. In addition, terms such as “include”, “have”, and any variant thereof are intended to cover a non-exclusive inclusion. For example, a process, method, system, product, or device that includes a series of operations or units is not necessarily limited to those expressly listed operations or units, but may include other operations or units not expressly listed or inherent to such a process, method, product, or device.

### Interpretation of Nouns:

Adversarial attack sample: may be generated by adding a perturbation to an original sample while semantics of the original sample is maintained to the greatest extent, and may be configured to attack a model to find a vulnerability of the model. The adversarial attack sample may be configured to find the vulnerability of the model, and then adjust the model to enhance robustness of the model. Adversarial attack samples may be classified into attack samples at three levels: character/word/sentence. Typically, the adversarial attack sample and the original sample have a same annotation label.

Character-level attack: may correspond to an English letter or a Chinese character. At a character level, a character in an original sample may be replaced with a character with a similar form/homophone, and a perturbation is added by performing character-level addition/deletion/modification on the original sample, to generate an attack sample, which attacks a model to find a vulnerability of the model.

Word-level attack: may correspond to an English word or a Chinese word. At a word level, a word in an original sample may be replaced with a synonym, and a perturbation may be added by performing word-level addition/deletion/modification on the original sample, to generate an attack sample, which attacks a model to find a vulnerability of the model.

Sentence-level attack: may correspond to an English sentence or a Chinese sentence. A perturbation may be added at a sentence level, to generate an attack sample, which attacks a model to find a vulnerability of the model.

Textual adversarial attack: for a text data sample, an imperceptible perturbation may be added to cause incorrect prediction of a model, which tests robustness and defects of the model. Textual adversarial attacks may be classified into three attack manners: a character-level attack, a word-level attack, and a sentence-level attack.

Model robustness: robustness may be understood as tolerance of a model to a data change. It may be assumed that a relatively small bias occurs in data or a relatively small perturbation occurs in the model, which only causes a relatively small impact on an output of the model and still can generate a correct result, the model may be referred to as robust.

Corpus automatic annotation system: unlabeled corpus data may be pre-processed by using an algorithm, and a high-confidence label result may be automatically given to the corpus, and training data is produced for model training.

End-to-end: may be an automatic process from input to output. An input may be an original input, and an output is a desired result. For example, the original input is inputted into a model, and the model processes the input to output a result. The entire process is an end-to-end method.

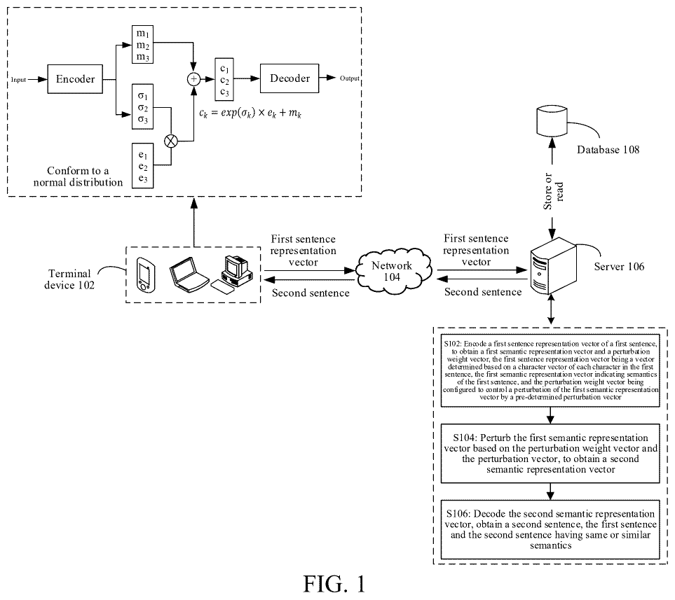

In an aspect of this disclosure, a sentence generation method is provided. In an example of an implementation, the sentence generation method may be applied to, but is not limited to, an application scenario shown in FIG. 1. In the application scenario shown in FIG. 1, a terminal device 102 may, but is not limited to, communicate with a server 106 over a network 104. The server 106 may, but is not limited to, perform an operation, such as a data writing operation or a data reading operation, on a database 108. The terminal device 102 may include, but is not limited to, a human-machine interaction screen, a processor, and a memory. The man-machine interaction screen may, but is not limited to, be configured to display a first sentence, a second sentence, or the like on the terminal device 102. The processor may, but is not limited to, be configured to perform, in response to a human-machine interaction operation, a corresponding operation; or generate a corresponding instruction, and transmit the generated instruction to the server 106. The memory is configured to store related processed data, such as a first semantic representation vector, a second semantic representation vector, and a second sentence.

In an example of an implementation, the following operations in the sentence generation method may be performed on the server 106. Operation S102: Encode a first sentence representation vector of a first sentence, to obtain a first semantic representation vector and a perturbation weight vector. The first sentence representation vector is related to a character vector of each character in the first sentence. For example, the first sentence representation vector is determined based on the character vector of each character in the first sentence. The first semantic representation vector indicates semantics of the first sentence. The perturbation weight vector is configured to control a perturbation of the first semantic representation vector by a pre-determined perturbation vector. Operation S104: Perturb the first semantic representation vector based on the perturbation weight vector and the perturbation vector, to obtain a second semantic representation vector. Operation S106: Decode the second semantic representation vector, to obtain a second sentence, the first sentence and the second sentence having same or similar semantics. Whether the semantics of the first sentence is the same as or similar to that of the second sentence is determined based on a distance between the first semantic representation vector and the second semantic representation vector.

The second sentence obtained by the foregoing method may be taken as a sentence-level adversarial attack sample, and is configured to evaluate robustness of a task processing model, which improves the robustness of the task processing model.

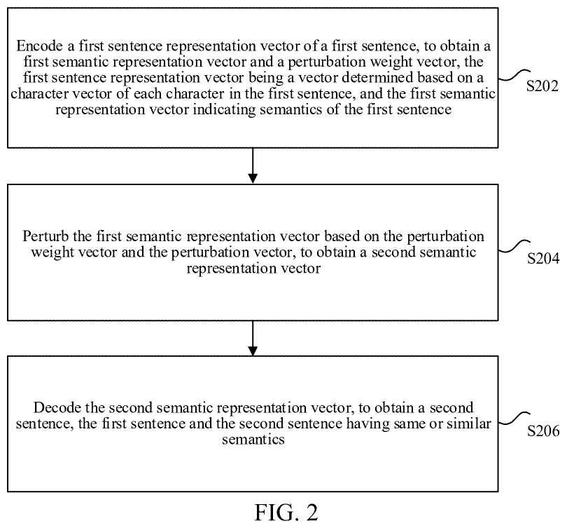

FIG. 2 is a flowchart of a sentence generation method according to an aspect of this disclosure. The method includes the following operations.

Operation S202: Encode a first sentence representation vector of a first sentence, to obtain a first semantic representation vector and a perturbation weight vector. The first sentence representation vector is related to a character vector of each character in the first sentence. For example, the first sentence representation vector is determined based on the character vector of each character in the first sentence. The first semantic representation vector indicates semantics of the first sentence. The perturbation weight vector is configured to control a perturbation of the first semantic representation vector by a pre-determined perturbation vector.

Operation S204: Perturb the first semantic representation vector based on the perturbation weight vector and the perturbation vector, to obtain a second semantic representation vector.

Operation S206: Decode the second semantic representation vector, to obtain a second sentence, the first sentence and the second sentence having same or similar semantics.

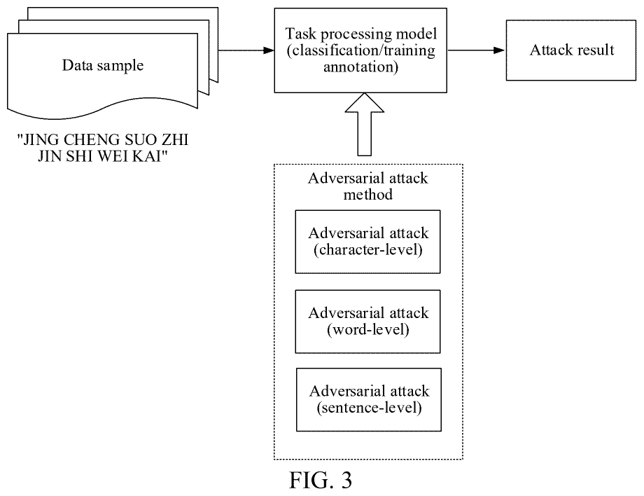

FIG. 3 is a schematic diagram of another application scenario of a sentence generation method according to an aspect of this disclosure. As shown in FIG. 3, an original data sample is “JING CHENG SUO ZHI JIN SHI WEI KAI”.

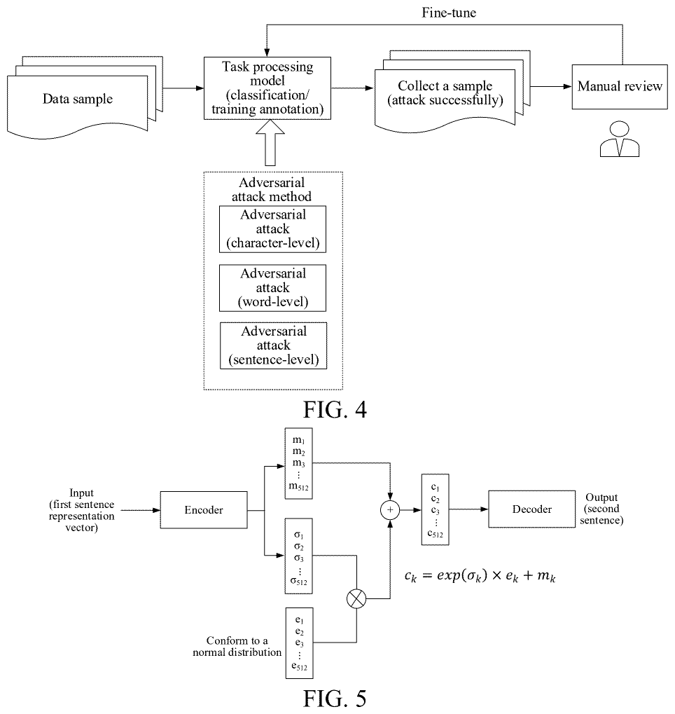

FIG. 4 is a schematic diagram of still another application scenario of a sentence generation method according to an aspect of this disclosure. As shown in FIG. 4, when adversarial training is performed on the task processing model by using the textual adversarial attack method, a training result is manually reviewed, a vulnerability of the task processing model is determined, and the task processing model is fine-tuned, whereby robustness of the task processing model when encountering adversarial attack text is improved.

In the related art, a method for generating a character-level adversarial attack sample and a method for generating a word-level adversarial attack sample are provided. However, there is no effective solution for generating sentence-level adversarial attack text.

Therefore, the aspects of this disclosure provide a sentence-level adversarial attack text generation method based on an encoder-decoder structure.

Specifically, FIG. 5 is a schematic diagram of a sentence generation method according to an aspect of this disclosure. Text generated by the method is adversarial attack text. As shown in FIG. 5, a first sentence representation vector of a first sentence is inputted into an encoder as an input, to obtain a first semantic representation vector m having a dimension of 512×512 and a perturbation weight vector σ having a dimension of 512×512. For example, the perturbation weight vector σ is a vector obtained by random sampling according to Gaussian distribution. σ is configured to distribute a weight to perturbation information, and is specifically exp(σ)×e. e may be, but is not limited to, a perturbation vector that conforms to a normal distribution. The first semantic representation vector m includes {m₁, m₂, m₃ . . . m₅₁₂}, and the perturbation weight vector σ includes {σ₁, σ₂, σ₃ . . . σ₅₁₂}, and the perturbation vector e includes {e₁, e₂, e₃ . . . e₅₁₂}. A second semantic representation vector c corresponds to cₖ in FIG. 5, and includes {c₁, c₂, c₃ . . . c₅₁₂}.

To understand the technical solutions in various aspects of this disclosure, a description is made by using an example in which the dimension of the first semantic representation vector is 512×512.

For example, if the first sentence is “JING CHENG SUO ZHI JIN SHI WEI KAI”, the first sentence representation vector of the first sentence is encoded to obtain the first semantic representation vector of 512 (a length of characters in the sentence)×512 (a vector dimension of each character). Each character in “JING CHENG SUO ZHI JIN SHI WEI KAI” is converted into a vector having a dimension of 1×512, and the length of the characters in the sentence is defined as 512 bytes. In a case that a number of characters (a character length) in the sentence is less than 512 bytes, the number of characters is converted into 512 bytes by complementing 0.

The first semantic representation vector is perturbed based on the perturbation weight vector σ and the perturbation vector e, to obtain a second semantic representation vector c having a dimension of 512×512. The second semantic representation vector c is decoded by using a decoder, to obtain decoded text, that is, obtain a second sentence.

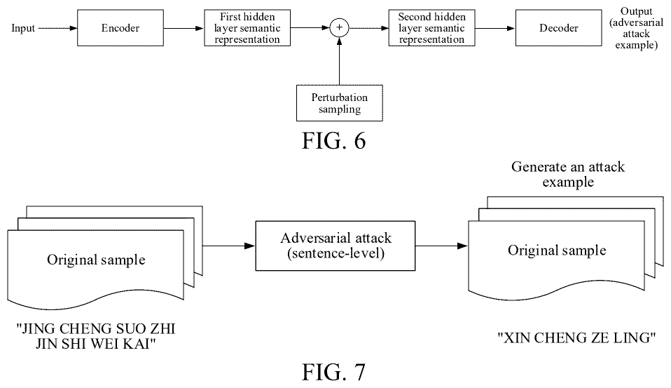

The adversarial attack text generation method based on the encoder-decoder structure is further described below with reference to FIG. 6. FIG. 6 is another schematic diagram of a sentence generation method according to an aspect of this disclosure. Text generated by the method is adversarial attack text. Operation S61: Input an original sample (a first sentence) into an encoder as an input, to obtain a first hidden layer semantic representation of the original sample at a hidden layer.

Operation 562: Sample perturbation information that conforms to a data distribution (such as a normal distribution) according to the data distribution, and add the sampled perturbation information to the first hidden layer semantic representation, to obtain a second hidden layer semantic representation.

Operation S63: Input the second latent semantic representation into a decoder, to obtain decoded text (a second sentence) after decoding.

Operation S64: Determine the decoded text as a generated adversarial attack sample.

Through operation S61 to operation S64, a plurality of adversarial attack samples in the form of text (adversarial attack text) may be generated. A model is trained based on the plurality of adversarial attack samples, and is fine-tuned, to enhance robustness of the model.

FIG. 7 is a diagram of a specific example of a sentence generation method according to an aspect of this disclosure. As shown in FIG. 7, it is assumed that a first sentence is “JING CHENG SUO ZHI JIN SHI WEI KAI”. According to operation S61 to operation S64, the perturbation information is acted on the first sentence based on a perturbation weight parameter, and an action result is decoded to obtain a second sentence “XIN CHENG ZE LING”. Implementation processes of encoding and decoding are described below with reference to specific aspects.

According to the foregoing aspects provided in this disclosure, the first semantic representation vector of the first sentence is perturbed based on the perturbation weight vector and the perturbation vector, to obtain the second semantic representation vector; and then, the second semantic representation vector is decoded, to obtain the second sentence having semantics the same as or similar to that of the first sentence, and the second sentence is taken as a sentence-level adversarial attack sample, which fills the gap in the sentence-level text-based adversarial attack method in the related art. Therefore, the technical problem in the related art that robustness of a task processing model cannot be evaluated by the sentence-level text adversarial attack method is solved, and a technical effect of improving the robustness of the task processing model is achieved.

As an example, the operation of encoding a first sentence representation vector of a first sentence, to obtain a first semantic representation vector and a perturbation weight vector includes:
the first sentence representation vector is passed through N encoders having a same structure in sequence, to obtain the N^{th} sentence encoded vector, N being a positive integer greater than or equal to 1;
first linear transformation is performed on the N^{th} sentence encoded vector, to obtain the first semantic representation vector; and
second linear transformation is performed on the N^{th} sentence encoded vector, to obtain the perturbation weight vector.

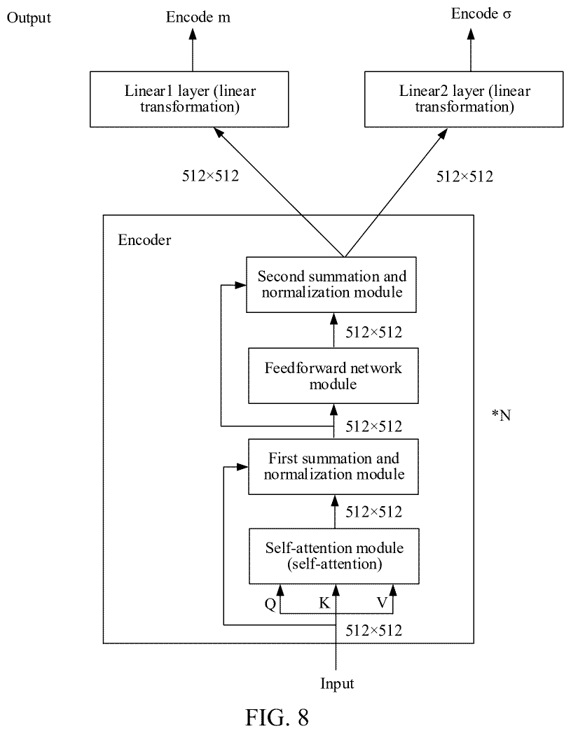

FIG. 8 is a schematic structural diagram of an encoder according to an aspect of this disclosure. As shown in FIG. 8, it is assumed that a number N of encoder layers is equal to 6, the first sentence representation vector is passed through the N encoders having the same structure in sequence. For example, the same structure refers to that the N encoders all include: a self-attention module, a feedforward network module, a first summation and normalization module, and a second summation and normalization module. Parameters of the N encoders are different.

In a processing process of the N encoders, an output of each encoder is inputted into a next encoder, and dimensions of the outputs of the encoders are the same, for example, are 512×512.

In an example of an implementation, the operation of passing the first sentence representation vector through N encoders having a same structure, to obtain an N^{th} sentence encoded vector includes:
the first sentence representation vector is inputted into the first encoder in the N encoders, to obtain the first sentence encoded vector; and
the following operation is performed in a case that N is greater than or equal to 2, to obtain the i^{th} sentence encoded vector, i being a positive integer greater than or equal to 2, and less than or equal to N:
the (i−1)^{th} sentence encoded vector is inputted into the i^{th} encoder in the N encoders, to obtain the i^{th} sentence encoded vector, the (i−1)^{th} sentence encoded vector being a sentence encoded vector outputted by the (i−1)^{th} encoder in the N encoders. In an example, the (i−1)^{th} sentence encoded vector may be referred to as a first sentence encoded vector, and the i^{th} sentence encoded vector may be referred to as a second self-attention vector.

In a case that a number N of encoders is 6, a sentence encoded vector that is outputted by the sixth encoder and that has a dimension of 512×512 is inputted into a Linear1 (a network structure 1 of linear transformation) layer, and first linear transformation is performed on the sentence encoded vector, to obtain a first semantic representation vector m. The sentence encoded vector that is outputted by the sixth encoder and that has the dimension of 512×512 is inputted into a Linear2 (a network structure 2 of linear transformation) layer, and second linear transformation is performed on the sentence encoded vector, to obtain a perturbation weight vector a.

The Linear1 layer and the Linear2 layer have a same network structure but different structure parameters.

In an example of an implementation, the operation of inputting the (i−1)^{th} sentence encoded vector to the i^{th} encoder in the N encoders, to obtain the i^{th} sentence encoded vector includes:
the (i−1)^{th} sentence encoded vector is inputted into a self-attention module in the i^{th} encoder, to obtain the it self-attention vector, the (i−1)^{th} sentence encoded vector and the i^{th} self-attention vector having a same dimension;
the i^{th} self-attention vector and the (i−1)^{th} sentence encoded vector are inputted into a first summation and normalization module in the i^{th} encoder, and the first summation and normalization module performs summation on the i^{th} self-attention vector and the (i−1)^{th} sentence encoded vector, to obtain a first summation vector, and normalizes the first summation vector, to obtain the i^{th} normalized vector, the (i−1)^{th} sentence encoded vector and the i^{th} normalized vector having a same dimension;
the i^{th} normalized vector is inputted into a feedforward network module in the i^{th} encoder, to obtain the i^{th} feedforward vector, the (i−1)^{th} sentence encoded vector and the i^{th} feedforward vector having a same dimension; and
the i^{th} normalized vector and the it feedforward vector are inputted into a second summation and normalization module in the i^{th} encoder, and the second summation and normalization module performs summation on the i^{th} normalized vector and the i^{th} feedforward vector, to obtain a second summation vector, and normalizes the second summation vector, to obtain the i^{th} sentence encoded vector, the (i−1)^{th} sentence encoded vector and the i^{th} sentence encoded vector having a same dimension.

A processing process of each layer of encoder is described below by using an example in which i is equal to 2 and with reference to FIG. 8.

Operation S81: Input the first sentence encoded vector into a self-attention module in the second encoder, to obtain the second self-attention vector.

In the aspects of this disclosure, a self-attention mechanism is applied to the self-attention module in the encoder. The self-attention mechanism is configured to determine semantic relevance between each token in a sequence (sentence) and another token in the sequence. According to the self-attention mechanism, a representation vector of each position in an input sequence (such as a sentence) is calculated; then, a weight distribution is calculated based on the representation vectors; and finally, the weight distribution is applied to each position in the input sequence, to obtain a weighted representation vector. In this manner, the self-attention mechanism allows a model in which the encoder is located to pay attention to any position in an input sequence when processing a current input, without relying on a previous calculation result. This enables the model in which the encoder is located to better capture a long-range dependency relationship in the input sequence.

A calculation algorithm of the self-attention mechanism is represented by formula (1):

$$Attention ( Q , K , V ) = soft max ( \frac{{QK}^{T}}{\sqrt{{d}_{k}}} ) V \qquad ( 1 )$$

where Q is an input vector representation of an original sample. For example, if the first sentence is “JING CHENG SUO ZHI JIN SHI WEI KAI”, Q is a vector representation (the first sentence representation vector) corresponding to the first sentence. In the self-attention mechanism, K=Q, and V=Q. Q, K, and V respectively indicate a query vector, a key vector, and a value vector.

A dimension of the first sentence representation vector is max_seq_length*hidden_size, where max_seq_length may be, but is not limited to, a maximum character length of original text (the first sentence), which may be understood as a size of a hidden layer here. It is assumed that the maximum character length of the first sentence is 512, the dimension of the second self-attention vector is 512×512.

Operation S82: Input the second self-attention vector in operation S81 and the first sentence encoded vector into a first summation and normalization module in the second encoder, to obtain the second normalized vector. The first summation and normalization module may first perform summation on the second self-attention vector and the first sentence encoded vector, to obtain a summation vector. By performing summation on the second self-attention vector outputted by the self-attention mechanism and the first sentence encoded vector, original information may be enhanced. Summation may be performed element by element (each element is added to an element at a position the same as that of the element).

Then, the summation vector is normalized. Normalization may be performed by using Norm(Q+Attention(Q, K, V)), where Norm is a normalization function. A dimension of the second normalized vector subjected to normalization is still 512×512. It is assumed that a result obtained after normalization is x₁.

An objective of normalization is to ensure retention of information before and after processing by the self-attention mechanism.

Operation S83: Input the second normalized vector into a feedforward network module in the second encoder, to obtain the second feedforward vector.

The feedforward network module includes a feedforward network. A result outputted by the feedforward network is Feed_forward(x₁), where Feed_forward is a calculation unit of the feedforward network. Dimensionality increase and dimensionality reduction are performed on the first normalized vector in sequence over the feedforward network. An objective is to further perform information integration on the first normalized vector outputted in operation S82. That is, input information (a vector representation) of each unit is finally outputted as a vector representation (namely, information integrating all text inputs) through matrix operation of the feedforward network and normalization. A dimension of the second feedforward vector is still 512×512.

Operation S84: Input the second feedforward vector and the second normalized vector to a second summation and normalization module in the second encoder, to obtain the second sentence encoded vector.

Specifically, normalization is performed by using Norm(x₁+Feed_forward(x₁)), to obtain the second sentence encoded vector.

Operation S81 to operation S84 are repeated for six times, and after the last layer of encoder outputs the sixth sentence encoded vector, the first semantic representation vector m and the perturbation weight vector σ that are finally outputted by the encoder are respectively obtained by using the Linear1 layer and the Linear2 layer shown in FIG. 8.

In an example of an implementation, the operation of performing first linear transformation on the N^{th} sentence encoded vector, to obtain a first semantic representation vector includes: the N^{th} sentence encoded vector is multiplied by a first weight matrix, to obtain the first semantic representation vector, a dimension of the N^{th} sentence encoded vector and a dimension of the first weight matrix being both M×M, and M being a positive integer greater than or equal to 2; and
the operation of performing second linear transformation on the N^{th} sentence encoded vector, to obtain a perturbation weight vector includes: the N^{th} sentence encoded vector is multiplied by a second weight matrix, to obtain the perturbation weight vector, the dimension of the Nth sentence encoded vector and a dimension of the second weight matrix being both M×M, and the first weight matrix and the second weight matrix being different weight matrices. The perturbation weight vector outputted by the encoder reflects a weight at each position of the sentence.

For example, it is assumed that N=6, the sixth sentence encoded vector outputted by a second summation and normalization module in the sixth encoder is multiplied by the first weight matrix, to obtain the first semantic representation vector m. The sixth sentence encoded vector is multiplied by the second weight matrix, to obtain the perturbation weight vector σ. Dimensions of the first semantic representation vector m and the perturbation weight vector σ are the same, and are both 512×512.

As an example, the operation of perturbing the first semantic representation vector based on the perturbation weight vector and the perturbation vector, to obtain a second semantic representation vector includes:
a perturbation encoded vector is determined based on the perturbation weight vector and the perturbation vector, the perturbation encoded vector and the first semantic representation vector having a same dimension; and
summation is performed on the perturbation encoded vector and the first semantic representation vector, to obtain the second semantic representation vector.

The operation of determining a perturbation encoded vector based on the perturbation weight vector and the perturbation vector includes:
the perturbation weight vector subjected to exponential operation is multiplied by a vector of each row in the perturbation vector, to obtain a vector of each row in the perturbation encoded vector; and
the operation of performing summation on the perturbation encoded vector and the first semantic representation vector, to obtain the second semantic representation vector includes:
summation is performed on the vector of each row in the perturbation encoded vector and a vector of a corresponding row in the first semantic representation vector, to obtain the second semantic representation vector.

With refer to the method for generating an adversarial attack example by adding a human-imperceptible perturbation to the text data sample that is mentioned in the foregoing aspect, the perturbation vector is acted on the first semantic representation vector, to obtain the second semantic representation vector.

In an aspect, the operation of perturbing the first semantic representation vector based on the perturbation weight vector and the perturbation vector, to obtain a second semantic representation vector includes:
the second semantic representation vector is obtained by using formula (2):

$${c}_{k} = exp ( {σ}_{k} ) \times {e}_{k} + {m}_{k} \qquad ( 2 )$$

where cₖ is a vector, having a dimension of 1×M, of a k^{th} row in the second semantic representation vector, σₖ indicates a vector, having a dimension of 1×M, of a k^{th} row in the perturbation weight vector, eₖ indicates a vector, having a dimension of 1×M, of a k^{th} row in the perturbation vector, exp(σₖ)×eₖ indicates a vector, having a dimension of 1×M, of a k^{th} row in the perturbation encoded vector, mₖ indicates a vector, having a dimension of 1×M, of a k^{th} row in the first semantic representation vector, k is a positive integer greater than or equal to 1, and less than or equal to M, a dimension of the perturbation weight vector, a dimension of the perturbation vector, a dimension of the perturbation encoded vector, a dimension of the first semantic representation vector, and a dimension of the second semantic representation vector are all M×M, and M is a positive integer greater than or equal to 2.

σ is configured to control a degree of perturbation of original input information by perturbation information. The perturbation weight vector exp(σₖ) subjected to exponential operation is multiplied by a vector of a k^{th} row in the perturbation vector e, to obtain a vector of a k^{th} row in the perturbation encoded vector. By analogy, a perturbation encoded vector having a dimension of M×M (512×512) is obtained. Summation is performed on the perturbation encoded vector and the first semantic representation vector to integrate the perturbation information with information included in the first sentence, to obtain the second semantic representation vector.

According to the foregoing method, the degree of perturbation may be set based on the perturbation weight vector, to control a semantic distance between the second semantic representation vector and the first semantic representation vector. In this way, the semantic distance between the generated sentence-level adversarial attack sample and the original input sample is controllable. This aligns with a fundamental objective of generating an adversarial attack sample. That is, perturbation is performed on a sentence level in a case that the semantics of the adversarial attack sample is similar to that of the original sample, to obtain a corresponding sample with similar semantics/intention. By the method, validity of the generated adversarial attack sample can be improved. In addition, perturbation information of different degrees of perturbation may be added to the original input sample by adjusting the perturbation weight vector, which increases diversity of a hidden layer representation of the original input sample, and improves diversity of the generated adversarial attack sample.

As an example of an implementation, the operation of decoding the second semantic representation vector, to obtain a second sentence includes:
the second semantic representation vector is passed through P decoders having a same structure in sequence, to obtain the P^{th} sentence decoded vector, P being a positive integer greater than or equal to 1;
third linear transformation is performed on the P^{th} sentence decoded vector, to obtain a second sentence representation vector; and
the second sentence is determined based on the second sentence representation vector.

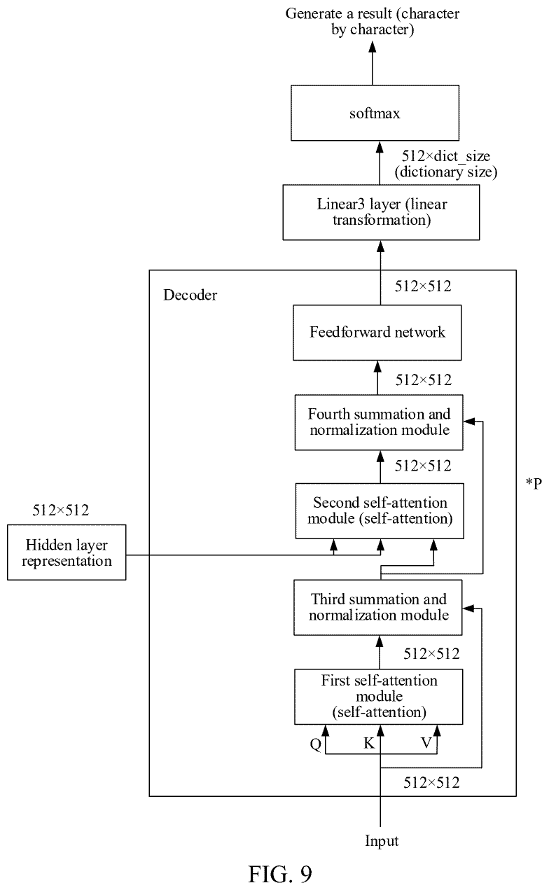

FIG. 9 is a schematic structural diagram of a decoder according to an aspect of this disclosure. As shown in FIG. 9, the decoder model includes P decoders connected in sequence. The P decoders have the same structure, which means, for example, that the P decoders all include a first self-attention module, a third summation and normalization module, a second self-attention module, a fourth summation and normalization module, and a feedforward network module. The P decoders have the same structure but different parameters.

In FIG. 9, the aspect of this disclosure is described by taking a detailed structure of one of the decoders as an example. The foregoing second semantic representation vector is passed through P decoders having the same structure in sequence, to obtain the P^{th} sentence decoded vector, namely, a sentence decoded vector outputted by a feedforward network in the P^{th} decoder.

Third linear transformation is performed on the P^{th} sentence decoded vector by using a linear transformation structure in a Linear3 layer shown in FIG. 9, to obtain the second sentence representation vector, and further, the second sentence is determined.

As an example, the operation of passing the second semantic representation vector through P decoders having a same structure in sequence, to obtain the P^{th} sentence decoded vector includes:
the second semantic representation vector and a preset initiator are inputted into the first decoder in the P decoders, to obtain the first sentence decoded vector; and
the following operation is performed to obtain the j^{th} sentence decoded vector in a case that P is greater than or equal to 2, j being a positive integer greater than or equal to 2, and less than or equal to P:
the second semantic representation vector and the (j−1)^{th} sentence decoded vector are inputted into the j^{th} decoder in the P decoders, to obtain the j^{th} sentence decoded vector, the (j−1)^{th} sentence decoded vector being a sentence decoded vector outputted by the (j−1)^{th} decoder in the P decoders. In an example, the (j−1)^{th} sentence decoded vector may be referred to as a first sentence decoded vector, and the j^{th} sentence decoded vector may be referred to as a second self-attention vector.

It is assumed that P=6, for the first decoder, the preset initiator is inputted into the first decoder, and is processed by using a first self-attention module, a third summation and normalization module, a second self-attention module, a fourth summation and normalization module, and a feedforward network module in the first decoder, to obtain the first sentence decoded vector.

The second semantic representation vector is taken as an input of a middle layer of the first decoder, that is, is taken as an input of the second self-attention module.

The second semantic representation vector and the first sentence decoded vector are inputted into the second decoder, to obtain the second sentence decoded vector; the second semantic representation vector and the second sentence decoded vector are inputted into the third decoder, to obtain the third sentence decoded vector; and by analogy, the sixth sentence decoded vector outputted by the sixth decoder is obtained.

As an example of an implementation, the operation of inputting the second semantic representation vector and the (j−1)^{th} sentence decoded vector into the j^{th} decoder in the P decoders, to obtain the j^{th} sentence decoded vector includes:
the (j−1)^{th} sentence decoded vector is inputted into a first self-attention module in the j^{th} decoder, to obtain the j^{th} first self-attention vector, the (j−1)^{th} sentence decoded vector and the j^{th} self-attention vector having a same dimension;
the j^{th} self-attention vector and the (j−1)^{th} sentence decoded vector are inputted into a third summation and normalization module in the j^{th} decoder, to obtain the j^{th} third normalized vector, the (j−1)^{th} sentence decoded vector and the j^{th} third normalized vector having a same dimension, and the third summation and normalization module being configured to perform summation on the j^{th} self-attention vector and the (j−1)^{th} sentence decoded vector, to obtain a third summation vector, and normalize the third summation vector, to obtain the j^{th} third normalized vector;
the j^{th} third normalized vector and the second semantic representation vector are inputted into a second self-attention module in the j^{th} decoder, to obtain the j^{th} second self-attention vector, the j^{th} third normalized vector, the second semantic representation vector, and the j^{th} second self-attention vector having a same dimension;
the j^{th} second self-attention vector and the j^{th} third normalized vector are inputted into a fourth summation and normalization module in the j^{th} decoder, to obtain the j^{th} fourth normalized vector, the j^{th} second self-attention vector and the j^{th} fourth normalized vector having a same dimension, and the fourth summation and normalization module being configured to perform summation on the j^{th} second self-attention vector and the j^{th} third normalized vector, to obtain a fourth summation vector, and normalize the fourth summation vector, to obtain the j^{th} fourth normalized vector; and
the j^{th} fourth normalized vector is inputted into a feedforward network module in the j^{th} decoder, to obtain the j^{th} sentence decoded vector, the j^{th} fourth normalized vector and the j^{th} sentence decoded vector having a same dimension.

It is assumed that j=2, the foregoing implementation process of obtaining the j^{th} sentence decoded vector is described with reference to the structure of the decoder shown in FIG. 9.

Operation S91: Input the first sentence decoded vector into a first self-attention module in the second decoder, to obtain the second first self-attention vector.

For a self-attention calculation method, refer to formula (1). Details are not described herein again. The function of the first self-attention module is to understand information inputted into the second decoder.

Operation S92: Input the second first self-attention vector and the first sentence decoded vector in operation S91 into a third summation and normalization module in the second encoder, to obtain the second third normalized vector.

For a normalization process, refer to the description of operation S82 in the foregoing encoder aspect. A dimension of the second third normalized vector subjected to normalization is still 512×512.

An objective of normalization is to ensure retention of information before and after processing by the self-attention module.

Operation S93: Input the second third normalized vector and the second semantic representation vector into a second self-attention module in the second decoder, to obtain the second self-attention vector having a dimension of 512×512.

In the process of self-attention processing, a second semantic representation vector c outputted by an encoder is taken as values of Q and K in second self-attention calculation, and the second third normalized vector outputted in operation S92 is taken as V, and self-attention calculation is performed by using formula (1), to obtain the second self-attention vector having the dimension of 512×512.

The second self-attention module in the decoder is configured to perform information integration on the second semantic representation vector obtained after perturbation information is added and the second third normalized vector.

Operation S94: Input the second self-attention vector and the second third normalized vector into a fourth summation and normalization module in the second decoder, to obtain the second fourth normalized vector having a dimension of 512×512.

For a process of normalization, refer to the description of operation S92. Details are not described herein again.

Operation S95: Input the second fourth normalized vector into a feedforward network module in the second decoder, to obtain the second sentence decoded vector having a dimension of 512×512.

The feedforward network in the second decoder is configured to perform deep calculation on the final integrated information. For a calculation formula, refer to the description of operation S83.

Operation S91 to operation S95 are repeatedly performed for six times (P=6), and after the last layer of decoder outputs the sixth sentence decoded vector, the second sentence finally outputted by the decoder is obtained by using the Linear3 layer and softmax shown in FIG. 9.

As an example, the operation of performing third linear transformation on the P^{th} sentence decoded vector, to obtain a second sentence representation vector includes: the P^{th} sentence decoded vector having a dimension of M×M is multiplied by a third weight matrix having a dimension of M×T, to obtain the second sentence representation vector having a dimension of M×T, T indicating a number of characters included in a preset dictionary, and T being a positive integer greater than or equal to 2; and
the operation of determining the second sentence based on the second sentence representation vector includes: the second sentence representation vector having the dimension of M×T is normalized, to obtain a normalized vector having a dimension of M×T; and a character at the q^{th} position in the preset dictionary is determined as a character in the second sentence in a case that a value of a vector, having a dimension of 1×T, of a k^{th} row in the normalized vector having the dimension of M×T satisfies a condition for determining a corresponding character from the preset dictionary and a value at the q^{th} position in the vector, having the dimension of 1×T, of the k^{th} row is the largest, k being a positive integer greater than or equal to 1, and less than or equal to M, and q being a positive integer greater than or equal to 1, and less than or equal to T.

It is assumed that P=6 and M=512, in a case that the second semantic representation vector is passed through six decoders having a same structure, to obtain the sixth sentence decoded vector outputted by a feedforward network in the sixth decoder, the second sentence representation vector is obtained by linear transformation in the Linear3 layer. Specifically, the sixth sentence decoded vector having a dimension of 512×512 is multiplied by the third weight matrix having a dimension of 512×1000, to obtain the second sentence representation vector having a dimension of 512×1000, where 1000 indicates a number of characters included in the preset dictionary.

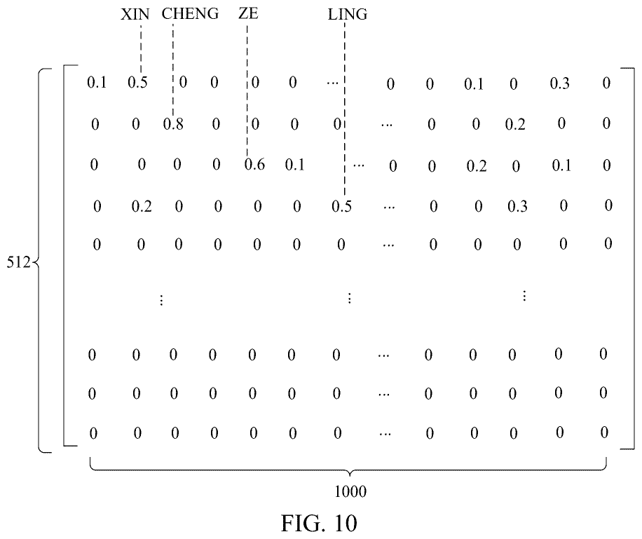

Because 1000 characters in the dictionary all participate in calculation, after softmax (normalization) is performed on the second sentence representation vector having the dimension of 512×1000, a normalized vector having a dimension of 512×1000 shown in FIG. 10 is obtained. Specifically, a character having a probability is predicted by using a softmax classifier, and a next generated character is predicted. A calculation process of the softmax classifier may be implemented by formula (3):

$$p ( y \vert x ) = \frac{exp ( {W}_{y} \cdot x )}{{\sum }_{t = 1}^{T} exp ( {W}_{t} \cdot x )} \qquad ( 3 )$$

where W is a model parameter, T is a size of the dictionary (such as 1000 characters), t is a sequence number of each character in the dictionary, and p(y|x) indicates a probability that the softmax classifier predicts y as an output given an output x of the feedforward network.

In other words, the 1000 characters in the dictionary are traversed, a prediction probability of each of the 1000 characters is calculated with reference to formula (3), and TopN characters having largest prediction probabilities are selected as candidate results.

The case that the value of the vector, having the dimension of 1×T, in the k^{th} row in the normalized vector having the dimension of M×T satisfies the condition for determining the corresponding character in the preset dictionary includes, but is not limited to: a case that at least some values of T values in the row are greater than 0 and less than 1; and a case that the at least some values are greater than a preset value, for example, greater than 0.6, 0.7, or 0.8.

For a vector, having a dimension of 1×1000, of each row, softmax outputs a prediction probability of each character, and a sum of the probabilities of the characters is 1. A character having a largest value in the 1000 probability values in each row is determined as the word in the second sentence.

For example, for the first row in the normalized vector, if a value at the second position is the largest, it means that the second character “XIN” in the dictionary is the character in the second sentence. For the second row in the normalized vector, if a value at the third position is the largest, it means that the third character “CHENG” in the dictionary is the character in the second sentence. For the third row in the normalized vector, if a value at the fifth position is the largest, it means that the fifth character “ZE” in the dictionary is also the character in the second sentence. By analogy, a plurality of characters included in the second sentence may be determined.

The implementation process of the decoder is described below by using an example in which the first sentence originally inputted into the encoder is “JING CHENG SUO ZHI JIN SHI WEI KAI”, and parameters of candidate generation result beam search are beam_number=1 and P=6, respectively.

Operation S1002: After a first sentence representation vector of a first sentence is inputted into an encoder shown in FIG. 8 to obtain a second semantic representation vector including perturbation information, input the second semantic representation vector into a self-attention mechanism of a decoder (input the second semantic representation vector in all subsequent operations).

Operation S1004: Input a preset initiator [CLS] to the decoder. The decoder generates different candidate characters for a position of each character in the to-be-generated second sentence, and the different candidate characters correspond to different search paths. A result with a maximum probability is selected as an output of the decoder, namely, the output character “XIN” (refer to FIG. 10). The maximum probability refers to a search path with a maximum cumulative probability.

Operation S1006: Concatenate the input (the preset initiator [CLS]) in operation S1004 with the output character “XIN”, and input a concatenation result to the decoder, and select a result with a maximum probability as an output of the decoder, namely, an output character “CHENG”.

Operation S1008: Concatenate the input with the output character in operation S1006 to obtain “[CLS] XIN CHENG”, take the concatenation result as an input of the decoder, and select a result with a maximum probability as an output of the decoder, namely, an output character “ZE”.

Operation S1010: Concatenate the input with the output character in operation S1008 to obtain “[CLS] XIN CHENG ZE”, take the concatenation result as an input of the decoder, and select a result with a maximum probability as an output of the decoder, namely, an output character “LING”.

Operation S1012: Concatenate the input with the output character in operation S1010 to obtain “[CLS] XIN CHENG ZE LING”, take the concatenation result as an input of the decoder, and select a result with a maximum probability as an output of the decoder, namely, an output character terminator “[EOS]”.

When the decoder outputs the terminator, the process of generating the second sentence ends.

Operation S1014: Perform post-processing.

The initiator [CLS] and the terminator [EOS] are removed, and finally generated adversarial attack text is “XIN CHENG ZE LING”.

The foregoing is an example of a process of generating the sentence-level candidate attack sample “XIN CHENG ZE LING” by passing the first sentence “JING CHENG SUO ZHI JIN SHI WEI KAI” through the encoder-decoder structure.

The following describes a sorting and screening process of candidate adversarial attack text.

### (I) Generation of Candidate Adversarial Attack Text Based on Beam Search Algorithm

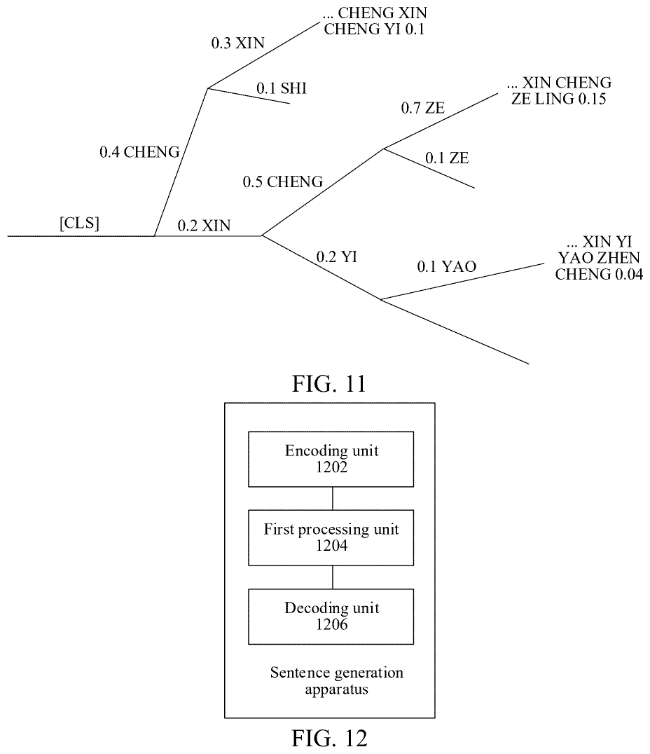

As shown in FIG. 11, a second semantic representation vector “JING CHENG SUO ZHI JIN SHI WEI KAI” is inputted into a decoder, and the decoder may output the following results: “CHENG XIN CHENG YI”, “XIN CHENG ZE LING”, “XIN YI YAO ZHEN CHENG”, and the like. Cumulative probabilities corresponding to different generation results are different.

In a process in which the decoder generates the candidate result character by character, different candidate characters are generated for each position of each character in a to-be-generated second sentence, and then first k candidate characters are selected. Different candidate characters correspond to different search paths (paths for short). The first k candidate characters are first k candidate characters in paths with maximum cumulative probabilities that are selected from candidate characters at each position. There are different generation results in different paths. In this way, a plurality of candidate results may be obtained. According to a greedy algorithm (that is, beam_number=1), taking a path with a maximum probability each time may not necessarily result in a generation result with a maximum cumulative probability. Therefore, a beam search algorithm is adopted in the aspects of this disclosure. In the beam search algorithm, in a process of traversing a path and generating an adversarial attack example character by character, first beam_number (a number of candidates with maximum probabilities for each node) candidates with maximum probabilities are selected and subjected to a next generation operation of the decoder.

As shown in FIG. 11, after the initiator [CLS] is inputted at a position of the first character of the to-be-generated second sentence, two candidate paths, namely, “CHENG” (with a probability of 0.4) and “XIN” (with a probability of 0.2), are selected and subjected to a next generation operation of the decoder. Next, for the path “CHENG”, two paths with maximum probabilities, namely, “CHENG XIN” and “CHENG SHI”, are selected and subjected to a next generation operation. For the path “XIN”, two paths with maximum probabilities, namely, “XIN CHENG” and “XIN YI”, are selected and subjected to a next generation operation. By analogy, a plurality of candidate adversarial attack text, such as “XIN CHENG ZE LING”, “CHENG XIN CHENG YI”, and “XIN YI YAO ZHENG CHENG”, may be generated.

### (II) Screening of Candidate Generation Results Based on Policies and Rules

For different tasks, the candidate adversarial attack text generated based on the beam search algorithm needs to be further screened. In the aspects of this disclosure, a rule-based screening method is adopted, which is specifically as follows:
a textual adversarial attack in a named entity recognition task background in the field of natural language processing is taken as an example. A candidate adversarial attack sample that satisfies a condition is filtered by using a regular expression, and a sample (a noise sample) that attacks a target entity is removed as follows:

```
  For candidate adversarial attack sample x in all adversarial attack
  samples:
  For i in range (n):
    If candidate adversarial attack sample does not satisfy regular
    expression
\hat{ }(?!.*\bENTITYi\b).+$
        Continue (loop)
      Else
          Remove candidate adversarial attack sample x (remove
the candidate adversarial attack sample)
```

where n is a number of correct named entities, and ENTITYi is the corresponding i^{th} correctly recognized named entity. The named entity is an entity having particular meaning in text, such as a proper noun, a person name, or a location name. An objective of the named entity recognition task is to recognize an entity in text and classify the entity. The case that the candidate anti-attack sample does not satisfy the regular expression \hat{ }(?!.*\bENTITYi\b).+$ may be understood as that ENTITYi is a substring of the candidate adversarial attack sample.

For example, for original text “The Yellow River Cantata was magnificent in the evening party”, a correct entity recognition result of named entity recognition is (song, “Yellow River Cantata”), and a number n of correct named entities is equal to 1. Four candidate adversarial attack samples are generated by the method provided in the aspects of this disclosure:

Candidate 1: “The Mother River sang with great momentum in the evening party”

Candidate 2: “The Yellow River Cantata was magnificent in the evening party”

Candidate 3: “The Yellow River Cantata in the evening performance was really nice and touching”

Candidate 4: “The Chorus of Yellow River performed tonight was so touching”

According to a filter algorithm, because Candidate 1 and Candidate 4 are matched with a correct entity result “Yellow River Cantata” and attack an entity that needs to be retained (the entity “Yellow River Cantata” is changed due to the attack), they are generated noise samples and need to be removed. The entity that needs to be retained is a substring that cannot be changed in the original text. Because Candidate 2 and Candidate 3 meet a task requirement (the named entity recognition task is attacked, but a target detected named entity is not attacked), they are retained and taken as finally filtered sentence-level text attack generation sample. Through the foregoing screening process, a sample that does not meet the requirement is screened out from the candidate adversarial attack samples.

According to the candidate adversarial attack samples determined by using the foregoing beam search algorithm, a plurality of words are selected in each operation to form a plurality of candidate adversarial attack samples, and a generation result with a maximum cumulative probability on different paths is taken as a candidate adversarial attack sample, which improves quality stability of the adversarial attack sample, and improves robustness of a model when the task processing model is adjusted based on the adversarial attack sample. The candidate adversarial attack samples are screened, whereby validity and quality of a finally obtained adversarial attack sample may be improved.

In addition, to ensure quality of the adversarial attack text generated by using the encoder-decoder-based model, the encoder-decoder-based model usually needs to be trained. A training process (test process) includes, but is not limited to, the following three phases:

### (1) Pre-Training of Encoder-Decoder-Based Model

Parameters of the coder-decoder-based model are pre-trained based on massive unlabeled corpus. Because an encoder-decoder-based language model needs to be a general language model, the model is pre-trained by using a related pre-training method.

### (2) Collection of Data

i) Collection of data source 1: Annotation: some pairs of original data and adversarial attack samples are manually annotated (such as a pair of samples “JING CHENG SUO ZHI JIN SHI WEI KAI” and “XIN CHENG ZE LING”).

ii) Collection of data source 2: A result of a related character/word-level attack is taken as an annotated sample pair. For example, in a current character-level adversarial attack algorithm, after “Read the history of the Great Ming” is attacked, “Read the History of the Ming Dynasty” is generated, that is, the former and the latter are considered as a sample pair and are taken as a training data source.

### (3) Fine-Tuning of Model

Based on the pre-trained model in operation (1), the model is fine-tuned based on the data in operation (2), to obtain final model parameters.

As an example, the foregoing method further includes:
in a case that the first sentence includes F characters, character vectors of the F characters in the first sentence are acquired, to obtain F character vectors having a dimension of 1×M, F being a positive integer greater than or equal to 2, and M being a positive integer greater than or equal to 2; and
in a case that F is less than M, the F character vectors having the dimension of 1×M are concatenated with M-F padding vectors having a dimension of 1×M, to obtain the first sentence representation vector having a dimension of M×M, values in the M-F padding vectors having the dimension of 1×M being all 0.

For example, it is assumed that M=512, and M indicates a maximum input length of each character, each character in the first sentence is converted into a character vector having a dimension of 1×512. In a case that the first sentence is “JING CHENG SUO ZHI JIN SHI WEI KAI”, F=8, and F is less than M, the 8 characters are all converted into character vectors having a dimension of 1×512, to obtain 8 character vectors having the dimension of 1×512, which is less than 512 character vectors having a dimension of 1×512. Then, 0 may be complemented on the remaining M-F (512-8) vectors having a dimension of 1×512, to obtain 504 complemented vectors having the dimension of 1×512.

In a case that F is equal to M, the F character vectors having the dimension of 1×M are concatenated, to obtain the first sentence representation vector having the dimension of M×M.

As an example, the method provided in the foregoing aspects further includes:
a to-be-tested target sentence recognition model is tested based on the first sentence and the second sentence, to obtain a target test result, the target test result indicating whether a same recognition result is recognized for the first sentence and the second sentence.

In a specific application scenario, it is assumed that the task processing model is a model configured to recognize a sentence, an implementation process of testing a target sentence recognition model based on the first sentence and the second sentence includes:
the first sentence is inputted into the target sentence recognition model, to obtain a first sentiment label, the first sentiment label indicating a sentiment type expressed by semantics of the first sentence;
the second sentence is inputted into the target sentence recognition model, to obtain a second sentiment label, the second sentiment label indicating a sentiment type expressed by semantics of the second sentence;
whether the first sentiment label is the same as the second sentiment label is determined;
in a case that the first sentiment label is the same as the second sentiment label, the target test result indicates that a same recognition result is recognized for the first sentence and the second sentence; and
in a case that the first sentiment label is different from the second sentiment label, the target test result indicates that different recognition results are recognized for the first sentence and the second sentence.

For example, it is assumed that preset sentiment labels are happy, sad, and angry, the first sentence is inputted into the target sentence recognition model, to obtain the first sentiment label; and the second sentence (the adversarial attack text) is inputted into the target sentence recognition model, to obtain the second sentiment label.

If the first sentiment label is the same as the second sentiment label, for example, are both happy, it indicates that in a case a relatively small bias occurs in an input sample or a relatively small perturbation occurs in the target sentence recognition model, the target sentence recognition model still outputs a correct result, which means that the adversarial attack text has relatively small impact on the target sentence recognition model, that is, robustness of the target sentence recognition model is high.

On the contrary, in a case that the first sentiment label is different from the second sentiment label, the following operations are performed:

In a case that the target test result indicates that different recognition results are recognized for the first sentence and the second sentence, prompt information is generated, the prompt information being configured to prompt to adjust the target sentence recognition model.

By adjusting the target sentence recognition model (which may also be understood as adversarial training), a vulnerability of the target sentence recognition model may be repaired, whereby robustness of the target sentence recognition model is rapidly increased.

In addition, in the process of generating the adversarial attack sample and performing adversarial training on the task processing model by using the sentence generation method, at least one of the following beneficial effect is achieved:

1. The technical solution in this disclosure provides the sentence-level adversarial attack sample generation solution for the adversarial attack method. That is, in addition to the character/word level, the sentence-level adversarial attack sample generation solution is provided, which fills the gap in the sentence-level textual adversarial attack method.

2. This disclosure provides the effective end-to-end solution for generating an effective adversarial attack sample. Compared with the related textual adversarial attack sample generation method in which addition/deletion/modification is performed based on the character/word level by using a rue and policy, in this disclosure, the encoder-decoder-based model automatically generates an adversarial attack sample by using an end-to-end method, which provides a novel idea and implementation method for adversarial attacks. A degree of perturbation may be set based on the perturbation weight vector, to control a semantic distance between the second semantic representation vector and the first semantic representation vector. In this way, the semantic distance between the generated sentence-level adversarial attack sample and the original input sample is controllable. This aligns with a fundamental objective of generating an adversarial attack sample. That is, perturbation is performed on a sentence level in a case that the semantics of the adversarial attack sample is similar to that of the original sample, to obtain a corresponding sample with similar semantics/intention. By the method, validity of the generated adversarial attack sample can be improved. In addition, perturbation information of different degrees of perturbation may be added to the original input sample by adjusting the perturbation weight vector, which increases diversity of a hidden layer representation of the original input sample, and improves diversity of the generated adversarial attack sample.

3. The method is applicable to a text classification task: the method is applied to a text classification task, and a vulnerability of a model and a corresponding sample are effectively found, whereby robustness of the model is rapidly increased and the vulnerability of the model is modified.

4. The method is applicable to a named entity recognition task: the method is applied to a named entity recognition task, and by the method of screening candidate generation results by using a policy and a rule, a sample that cannot be correctly predicted by a model may be effectively screened, and the model is effectively repaired.

For ease of description, the foregoing method aspects are described as a series of action combinations. However, those skilled in the art should recognize that this disclosure is not limited to the described order of the actions because some operations may be performed in another order or performed at the same time according to this disclosure. In addition, those skilled in the art also recognize that the aspects described in the description are all examples of aspects, and the involved actions and modules are not necessarily required.

In another aspect, the aspects of this disclosure provide a sentence generation apparatus shown in FIG. 12. The apparatus includes an encoding unit 1202, a first processing unit 1204, and a decoding unit 1206.

The encoding unit 1202 is configured to encode a first sentence representation vector of a first sentence, to obtain a first semantic representation vector and a perturbation weight vector. The first sentence representation vector is a vector determined based on a character vector of each character in the first sentence. The first semantic representation vector indicates semantics of the first sentence. The perturbation weight vector is configured to control a perturbation of the first semantic representation vector by a pre-determined perturbation vector.

The first processing unit 1204 is configured to perturb the first semantic representation vector based on the perturbation weight vector and the perturbation vector, to obtain a second semantic representation vector.

The decoding unit 1206 is configured to decode the second semantic representation vector, to obtain a second sentence. The first sentence and the second sentence have same or similar semantics.

The encoding unit 1202 includes:
a first processing module, configured to pass the first sentence representation vector through N encoders having a same structure in sequence, to obtain the N^{th} sentence encoded vector, N being a positive integer greater than or equal to 1;
a second processing module, configured to perform first linear transformation on the N^{th} sentence encoded vector, to obtain the first semantic representation vector; and
a third processing module, configured to perform second linear transformation on the N^{th} sentence encoded vector, to obtain the perturbation weight vector.

The first processing module includes:
a first processing sub-module, configured to
input the first sentence representation vector into the first encoder in the N encoders, to obtain the first sentence encoded vector; and
perform the following operation in a case that N is greater than or equal to 2, to obtain the i^{th} sentence encoded vector, i being a positive integer greater than or equal to 2, and less than or equal to N:
input the (i−1)^{th} sentence encoded vector into the i^{th} encoder in the N encoders, to obtain the i^{th} sentence encoded vector, the (i−1)^{th} sentence encoded vector being a sentence encoded vector outputted by the (i−1)^{th} encoder in the N encoders.

The first processing module includes:
a second processing sub-module, configured to input the (i−1)^{th} sentence encoded vector into a self-attention module in the i^{th} encoder, to obtain the i^{th} self-attention vector, the (i−1)^{th} sentence encoded vector and the it self-attention vector having a same dimension; a third processing sub-module, configured to input the i^{th} self-attention vector and the (i−1)^{th} sentence encoded vector into a first summation and normalization module in the i^{th} encoder, the first summation and normalization module performing summation on the i^{th} self-attention vector and the (i−1)^{th} sentence encoded vector, to obtain a first summation vector, and normalizing the first summation vector, to obtain the i^{th} normalized vector, and the (i−1)^{th} sentence encoded vector and the i^{th} normalized vector having a same dimension;
a fourth processing sub-module, configured to input the i^{th} normalized vector into a feedforward network module in the i^{th} encoder, to obtain the i^{th} feedforward vector, the (i−1)^{th} sentence encoded vector and the i^{th} feedforward vector having a same dimension; and
a fifth processing sub-module, configured to input the i^{th} normalized vector and the i^{th} feedforward vector into a second summation and normalization module in the i^{th} encoder, the second summation and normalization module performing summation on the i^{th} normalized vector and the i^{th} feedforward vector, to obtain a second summation vector, and normalizing the second summation vector, to obtain the i^{th} sentence encoded vector, the (i−1)^{th} sentence encoded vector and the i^{th} sentence encoded vector having a same dimension.

The second processing module includes:
a first multiplication sub-module, configured to multiply the N^{th} sentence encoded vector by a first weight matrix, to obtain the first semantic representation vector, a dimension of the N^{th} sentence encoded vector and a dimension of the first weight matrix being both M×M, and M being a positive integer greater than or equal to 2; and
the third processing module includes:
a second multiplication sub-module, configured to multiply the N^{th} sentence encoded vector by a second weight matrix, to obtain the perturbation weight vector, the dimension of the N^{th} sentence encoded vector and a dimension of the second weight matrix being both M×M, and the first weight matrix and the second weight matrix being different weight matrices.

The first processing unit 1204 includes:
a fourth processing module, configured to determine a perturbation encoded vector based on the perturbation weight vector and the perturbation vector, the perturbation encoded vector and the first semantic representation vector having a same dimension; and
a fifth processing module, configured to perform summation on the perturbation encoded vector and the first semantic representation vector, to obtain the second semantic representation vector.

The fifth processing module includes:
a sixth processing sub-module, configured to multiply the perturbation weight vector subjected to exponential operation by a vector of each row in the perturbation vector, to obtain a vector of each row in the perturbation encoded vector; and perform summation on the vector of each row in the perturbation encoded vector and a vector of a corresponding row in the first semantic representation vector, to obtain the second semantic representation vector.

The decoding unit 1206 includes:
a sixth processing module, configured to pass the second semantic representation vector through P decoders having a same structure in sequence, to obtain the P^{th} sentence decoded vector, P being a positive integer greater than or equal to 1;
a seventh processing module, configured to perform third linear transformation on the P^{th} sentence decoded vector, to obtain a second sentence representation vector; and
an eighth processing module, configured to determine the second sentence based on the second sentence representation vector.

The sixth processing module includes:
a seventh processing sub-module, configured to:
input the second semantic representation vector and a preset initiator into the first decoder in the P decoders, to obtain the first sentence decoded vector; and
perform the following operation to obtain the j^{th} sentence decoded vector in a case that P is greater than or equal to 2, j being a positive integer greater than or equal to 2, and less than or equal to P:
input the second semantic representation vector and the (j−1)^{th} sentence decoded vector into the j^{th} decoder in the P decoders, to obtain the j^{th} sentence decoded vector, the (j−1)^{th} sentence decoded vector being a sentence decoded vector outputted by the (j−1)^{th} decoder in the P decoders.

The sixth processing module further includes:
an eighth processing sub-module, configured to input the (j−1)^{th} sentence decoded vector into a first self-attention module in the j^{th} decoder, to obtain the j^{th} first self-attention vector, the (j−1)^{th} sentence decoded vector and the j^{th} self-attention vector having a same dimension;
a ninth processing sub-module, configured to input the j^{th} self-attention vector and the (j−1)^{th} sentence decoded vector into a third summation and normalization module in the j^{th} decoder, to obtain the j^{th} third normalized vector, the (j−1)^{th} sentence decoded vector and the j^{th} third normalized vector having a same dimension, and the third summation and normalization module being configured to perform summation on the j^{th} self-attention vector and the (j−1)^{th} sentence decoded vector, to obtain a third summation vector, and normalize the third summation vector, to obtain the j^{th} third normalized vector;
a tenth processing sub-module, configured to input the j^{th} third normalized vector and the second semantic representation vector into a second self-attention module in the j^{th} decoder, to obtain the j^{th} second self-attention vector, the j^{th} third normalized vector, the second semantic representation vector, and the j^{th} second self-attention vector having a same dimension;
an eleventh processing sub-module, configured to input the j^{th} second self-attention vector and the j^{th} third normalized vector into a fourth summation and normalization module in the j^{th} decoder, to obtain the j^{th} fourth normalized vector, the j^{th} second self-attention vector and the j^{th} fourth normalized vector having a same dimension, and the fourth summation and normalization module being configured to perform summation on the j^{th} second self-attention vector and the j^{th} third normalized vector, to obtain a fourth summation vector, and normalize the fourth summation vector, to obtain the j^{th} fourth normalized vector; and
a twelfth processing sub-module, configured to input the j^{th} fourth normalized vector into a feedforward network module in the j^{th} decoder, to obtain the j sentence decoded vector, the j^{th} fourth normalized vector and the j^{th} sentence decoded vector having a same dimension.

The seventh processing module includes:
a thirteenth processing sub-module, configured to multiply the P^{th} sentence decoded vector having a dimension of M×M by a third weight matrix having a dimension of M×T, to obtain the second sentence representation vector having a dimension of M×T, T indicating a number of characters included in a preset dictionary, and T being a positive integer greater than or equal to 2; and
the eighth processing module includes:
a fourteenth processing sub-module, configured to normalize the second sentence representation vector having the dimension of M×T, to obtain a normalized vector having a dimension of M×T; and determine a character at the q^{th} position in the preset dictionary as a character in the second sentence in a case that a value of a vector, having a dimension of 1×T, of a k^{th} row in the normalized vector having the dimension of M×T satisfies a condition for determining a corresponding character from the preset dictionary and a value at the q^{th} position in the vector, having the dimension of 1×T, of the k^{th} row is the largest, k being a positive integer greater than or equal to 1, and less than or equal to M, and q being a positive integer greater than or equal to 1, and less than or equal to T.

The apparatus further includes:
an acquisition unit, configured to acquire character vectors of F characters in the first sentence in a case that the first sentence includes the F characters, to obtain F character vectors having a dimension of 1×M, F being a positive integer greater than or equal to 2, and M being a positive integer greater than or equal to 2; and
a concatenation unit, configured to concatenate the F character vectors having the dimension of 1×M with M-F padding vectors having a dimension of 1×M in a case that F is less than M, to obtain the first sentence representation vector having a dimension of M×M, values in the M-F padding vectors having the dimension of 1×M being all 0.

The apparatus further includes:
a test unit, configured to test a to-be-tested target sentence recognition model based on the first sentence and the second sentence, to obtain a target test result, the target test result indicating whether a same recognition result is recognized for the first sentence and the second sentence.

The test unit includes:
a first input module, configured to input the first sentence into the target sentence recognition model, to obtain a first sentiment label, the first sentiment label indicating a sentiment type expressed by semantics of the first sentence;
a second input module, configured to input the second sentence into the target sentence recognition model, to obtain a second sentiment label, the second sentiment label indicating a sentiment type expressed by semantics of the second sentence; and
a comparison module, configured to determine whether the first sentiment label is the same as the second sentiment label, in a case that the first sentiment label is the same as the second sentiment label, the target test result indicating that a same recognition result is recognized for the first sentence and the second sentence, and in a case that the first sentiment label is different from the second sentiment label, the target test result indicating that different recognition results are recognized for the first sentence and the second sentence.

The apparatus further includes:
a second processing unit, configured to generate prompt information in a case that the target test result indicates that different recognition results are recognized for the first sentence and the second sentence, the prompt information being configured to prompt to adjust the target sentence recognition model.

The apparatus is applied to perturb the first semantic representation vector of the first sentence based on the perturbation weight vector and the perturbation vector, to obtain the second semantic representation vector. Then, the second semantic representation vector is decoded, to obtain the second sentence having semantics the same as or similar to that of the first sentence, and the second sentence is taken as a sentence-level adversarial attack sample, which fills the gap in the sentence-level text-based adversarial attack method in the related art. Therefore, the technical problem in the related art that robustness of a task processing model cannot be evaluated by the sentence-level text adversarial attack method is solved, and a technical effect of improving the robustness of the task processing model is achieved.

For examples of the aspects of the sentence generation apparatus herein, reference can be made to the foregoing aspects of the sentence generation method.

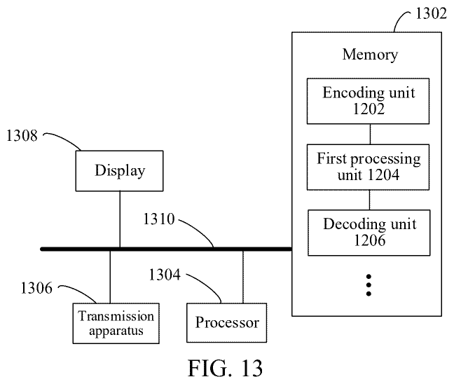

In still another aspect, the aspects of this disclosure further provide an electronic device for implementing the foregoing sentence generation method. The electronic device may be a terminal device shown in FIG. 13. In the aspects of this disclosure, a description is made by using an example in which the electronic device is a backend device. As shown in FIG. 13, the electronic device includes a memory 1302 and processing circuitry, such as processor 1304. The memory 1302 has a computer program stored therein, and the processor 1304 is configured to execute the computer program to perform the operations in any of the foregoing method aspects.

In the aspects of this disclosure, the electronic device may be located in at least one of a plurality of network devices in a computer network.

In the aspects of this disclosure, the processor may be configured to execute the computer program to perform the following operations:
S1: Encode a first sentence representation vector of a first sentence, to obtain a first semantic representation vector and a perturbation weight vector, the first sentence representation vector being a vector determined based on a character vector of each character in the first sentence, the first semantic representation vector indicating semantics of the first sentence, and the perturbation weight vector being configured to control a perturbation of the first semantic representation vector by a pre-determined perturbation vector;
S2: Perturb the first semantic representation vector based on the perturbation weight vector and the perturbation vector, to obtain a second semantic representation vector; and
S3: Decode the second semantic representation vector, to obtain a second sentence, the first sentence and the second sentence having same or similar semantics.

Those of ordinary skill in the art may understand that the structure shown in FIG. 13 is only an example. Alternatively, the electronic device may be a target terminal such as a smartphone (such as an Android mobile phone or an iOS mobile phone), a tablet computer, a palmtop computer, a mobile Internet device (MID), or a personal digital assistant (PDA). FIG. 13 does not limit the structure of the electronic device. For example, the electronic device may further include more or fewer components (such as a network interface) than those shown in FIG. 13, or has a configuration different from that shown in FIG. 13.

The memory 1302 may be configured to store a software program and a module, such as program instructions/modules corresponding to the sentence generation method and apparatus in the aspects of this disclosure. The processor 1304 executes various functional applications and data processing by running the software program and the module stored in the memory 1302, that is, implements the sentence generation method. The memory 1302 may include a high-speed random-access memory, and may further include a non-volatile memory, such as one or more magnetic storage apparatuses, a flash memory, or another non-volatile solid state memory. In some aspects, the memory 1302 may further include memories remotely disposed relative to the processor 1304, and the remote memories may be connected to a terminal through a network. Examples of the network include, but are not limited to, the Internet, an intranet, a local area network, a mobile communication network, and a combination thereof. The memory 1302 may be specifically, but is not limited to, configured to store a first sentence, a first semantic representation vector, a perturbation weight vector, and the like. As an example, as shown in FIG. 13, the memory 1302 may include, but is not limited to, the first acquisition unit 1202, the first processing unit 1204, and the decoding unit 1206 in the sentence generation apparatus. In addition, the memory may further include, but is not limited to, other modules and units in the sentence generation apparatus. Details are not described again in this example.

A transmission apparatus 1306 is configured to receive or transmit data over a network. Specific examples of the network may include a wired network and a wireless network. In an example, the transmission apparatus 1306 includes a network interface controller (NIC), which may be connected to another network device and a router via a network cable, to communicate with the Internet or a local area network. In an example, the transmission apparatus 1306 is a radio frequency (RF) module, which communicates with the Internet by using a wireless protocol.

In addition, the electronic device further includes: a display 1308, configured to display orientation prompt information of a target sound; and a connection bus 1310, configured to connect various module components in the electronic device.

In other aspects, the target terminal or server may be a node in a distributed system. The distributed system may be a blockchain system. The blockchain system may be a distributed system formed by a plurality of nodes connected in the form of network communication. A peer to peer (P2P) network may be formed by the nodes, any form of computing device, such as a server, a terminal, and another electronic device, may become a node in the blockchain system by joining the peer-to-peer network.

In still another aspect, this disclosure provides a computer program product or a computer program, which includes computer instructions. The computer instructions are stored in a computer-readable storage medium, such as a non-transitory computer-readable storage medium. A processor of a computer device reads the computer instructions from the computer-readable storage medium, and executes the computer instructions, to cause the computer device to perform the sentence generation method provided in the implementations of examples in the foregoing aspects such as server verification processing. The computer program, when run, is configured for performing the operations in any of the foregoing method aspects.

In the aspects of this disclosure, the computer-readable storage medium may be configured to store the computer program configured for performing the following operations:

S1: Encode a first sentence representation vector of a first sentence, to obtain a first semantic representation vector and a perturbation weight vector, the first sentence representation vector being a vector determined based on a character vector of each character in the first sentence, the first semantic representation vector indicating semantics of the first sentence, and the perturbation weight vector being configured to control a perturbation of the first semantic representation vector by a pre-determined perturbation vector;

S2: Perturb the first semantic representation vector based on the perturbation weight vector and the perturbation vector, to obtain a second semantic representation vector; and

S3: Decode the second semantic representation vector, to obtain a second sentence, the first sentence and the second sentence having same or similar semantics.

In the aspects of this disclosure, those of ordinary skill in the art may understand that all or some operations in the methods of the foregoing aspects may be performed by a program instructing relevant hardware of a target terminal. The program may be stored in a computer-readable storage medium. The storage medium may include: a flash drive, a read-only memory (ROM), a random-access memory (RAM), a magnetic disk, an optical disc, and the like.

The sequence numbers of the foregoing aspects of this disclosure are merely for description purpose but do not imply the preference among the aspects.

When the integrated unit in the foregoing aspects is implemented in the form of a software functional unit and sold or used as an independent product, the integrated unit may be stored in the computer-readable storage medium. Based on such an understanding, the technical solutions of this disclosure may be implemented in the form of a software product. The computer software product is stored in a storage medium and includes several instructions for instructing one or more computer devices (which may be a personal computer, a server, a network device, or the like) to perform all or some of the operations of the methods in the aspects of this disclosure.

In the foregoing aspects of this disclosure, the descriptions of the aspects have respective focuses. For a part that is not described in detail in an aspect, refer to related descriptions in other aspects.

In the several aspects provided in this disclosure, the disclosed client may be implemented in another manner. The foregoing described apparatus aspects are merely examples. For example, the unit division is merely logical function division and there may be other division manners in actual implementation. For example, a plurality of units or components may be combined or integrated into another system, or some features may be omitted or not performed. In addition, the coupling, or direct coupling, or communication connection between the displayed or discussed components may be the indirect coupling or communication connection through some interfaces, units, or modules, and may be electrical or of other forms.

The units described as separate parts may or may not be physically separate, and components displayed as units may or may not be physical units, that is, may be located in one position, or may be distributed on a plurality of network units. Some or all of the units may be selected based on an actual requirement to implement the objectives of the solutions in the aspects of this disclosure.

In addition, functional units in the aspects of this disclosure may be integrated into one processing unit, or each of the units may be physically separated, or two or more units may be integrated into one unit. The integrated unit may be implemented in the form of hardware, or may be implemented in the form of a software functional unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are merely implementations of examples of this disclosure. Those of ordinary skill in the art may further make several improvements and modifications without departing from the principle of this disclosure, and the improvements and modifications fall within the scope of protection of this disclosure.

What is claimed is:

1. A sentence generation method, comprising:
encoding a first sentence representation vector of a first sentence to obtain a first semantic representation vector and a perturbation weight vector,
the first sentence representation vector being determined based on a character vector of each respective character in the first sentence,
the first semantic representation vector indicating a plurality of semantics of the first sentence, and
the perturbation weight vector being configured to control a perturbation of the first semantic representation vector by a pre-determined perturbation vector;
perturbing the first semantic representation vector, based on the perturbation weight vector and the perturbation vector, to obtain a second semantic representation vector; and
decoding the second semantic representation vector to obtain a second sentence.

2. The method according to claim 1, wherein the encoding the first sentence representation vector comprises:
sequentially passing the first sentence representation vector through N encoders having a same structure to obtain an N^{th} sentence encoded vector, N being a positive integer greater than or equal to 1;
performing first linear transformation on the N^{th} sentence encoded vector to obtain the first semantic representation vector; and
performing second linear transformation on the N^{th} sentence encoded vector to obtain the perturbation weight vector.

3. The method according to claim 2, wherein the sequentially passing the first sentence representation vector comprises:
inputting the first sentence representation vector into a first encoder in the N encoders to obtain the first sentence encoded vector; and
inputting the first sentence encoded vector into a second encoder in the N encoders to obtain a second sentence encoded vector.

4. The method according to claim 3, wherein the inputting the first sentence encoded vector comprises:
inputting the first sentence encoded vector into a self-attention module in the second encoder to obtain a second self-attention vector, the first sentence encoded vector and the second self-attention vector having a same dimension;
inputting the second self-attention vector and the first sentence encoded vector into a first summation and normalization module in the second encoder, wherein the inputting the second self-attention vector comprises:
performing summation on the second self-attention vector and the first sentence encoded vector to obtain a first summation vector, and
normalizing the first summation vector to obtain the second normalized vector, the first sentence encoded vector and the second normalized vector having a same dimension;
inputting the second normalized vector into a feedforward network module in the second encoder to obtain the second feedforward vector, the first sentence encoded vector and the second feedforward vector having a same dimension; and
inputting the second normalized vector and the second feedforward vector into a second summation and normalization module in the second encoder, wherein the inputting the second normalized vector comprises:
performing summation on the second normalized vector and the second feedforward vector to obtain a second summation vector, and
normalizing the second summation vector to obtain the second sentence encoded vector, the first sentence encoded vector and the second sentence encoded vector having a same dimension.

5. The method according to claim 4, wherein
the performing the first linear transformation comprises:
multiplying the N^{th} sentence encoded vector by a first weight matrix to obtain the first semantic representation vector, a dimension of the N^{th} sentence encoded vector, and a dimension of the first weight matrix being both M×M,
wherein M is a positive integer greater than or equal to 2; and
the performing the second linear transformation comprises:
multiplying the N^{th} sentence encoded vector by a second weight matrix to obtain the perturbation weight vector, the dimension of the N^{th} sentence encoded vector, and a dimension of the second weight matrix being both M×M,
wherein the first weight matrix and the second weight matrix include different weight matrices.

6. The method according to claim 5, wherein the perturbing the first semantic representation vector comprises:
determining a perturbation encoded vector based on the perturbation weight vector and the perturbation vector, the perturbation encoded vector and the first semantic representation vector having a same dimension; and
performing summation on the perturbation encoded vector and the first semantic representation vector to obtain the second semantic representation vector.

7. The method according to claim 6, wherein
the determining a perturbation encoded vector includes multiplying the perturbation weight vector subjected to exponential operation by a vector of each row in the perturbation vector to obtain a vector of each row in the perturbation encoded vector; and
the second semantic representation vector is obtained by performing summation on the vector of each row in the perturbation encoded vector and a vector of a corresponding row in the first semantic representation vector.

8. The method according to claim 7, wherein the decoding the second semantic representation vector comprises:
sequentially passing the second semantic representation vector through P decoders having a same structure to obtain a P^{th} sentence decoded vector, wherein P is a positive integer greater than or equal to 1;
performing third linear transformation on the P^{th} sentence decoded vector to obtain a second sentence representation vector; and
determining the second sentence based on the second sentence representation vector,
wherein the plurality of semantics of the first sentence is same as or similar to that of the second sentence, as determined based on a distance between the first semantic representation vector and the second semantic representation vector.

9. The method according to claim 8, wherein the sequentially passing the second semantic representation vector comprises:
inputting the second semantic representation vector and a preset initiator into a first decoder in the P decoders to obtain the first sentence decoded vector; and
inputting the second semantic representation vector and a first sentence decoded vector into a second decoder in the P decoders to obtain a second sentence decoded vector.

10. The method according to claim 9, wherein the inputting the second semantic representation vector and the first sentence decoded vector comprises:
inputting the first sentence decoded vector into a first self-attention module in the second decoder to obtain a first self-attention vector, the first sentence decoded vector and the second self-attention vector having a same dimension;
inputting the second self-attention vector and the first sentence decoded vector into a third summation and normalization module in the second decoder to obtain a third normalized vector by performing summation on the second self-attention vector and the first sentence decoded vector by obtaining and normalizing a third summation vector,
the first sentence decoded vector and the third normalized vector having a same dimension,
inputting the third normalized vector and the second semantic representation vector into a second self-attention module in the second decoder to obtain the second self-attention vector, the third normalized vector, the second semantic representation vector, and the second self-attention vector having a same dimension;
inputting the second self-attention vector and the third normalized vector into a fourth summation and normalization module in the second decoder to obtain the a fourth normalized vector by performing summation on the second self-attention vector and the third normalized vector by obtaining and normalizing a fourth summation vector,
the second self-attention vector and the fourth normalized vector having a same dimension; and
inputting the fourth normalized vector into a feedforward network module in the second decoder, to obtain the second sentence decoded vector, the fourth normalized vector and the second sentence decoded vector having a same dimension.

11. The method according to claim 10, wherein
the performing the third linear transformation comprises:
multiplying the P^{th} sentence decoded vector, having a dimension of M×M, by a third weight matrix, having a dimension of M×T, to obtain the second sentence representation vector having a dimension of M×T,
wherein T indicates a number of characters comprised in a preset dictionary and is a positive integer greater than or equal to 2; and
the determining the second sentence comprises:
normalizing the second sentence representation vector, having the dimension of M×T, to obtain a normalized vector, having a dimension of M×T; and
determining a character at a q^{th} position in the preset dictionary as a character in the second sentence based on a value of a vector of a k^{th} row in the normalized vector satisfying a condition for determining a corresponding character from the preset dictionary and a value at the q^{th} position in the vector,
the value of the vector having a dimension of 1×T, the normalized vector having the dimension of M×T, the value at the q^{th} position in the vector having the dimension of 1×T, wherein the k^{th} row is a largest row,
wherein k is a positive integer greater than or equal to 1 and less than or equal to M, and q is a positive integer greater than or equal to 1 and less than or equal to T.

12. The method according to claim 11, further comprising:
acquiring character vectors of F characters in the first sentence to obtain F character vectors,
wherein the first sentence comprises the F characters and the F character vectors have a dimension of 1×M,
wherein F is a positive integer greater than or equal to 2 and M is a positive integer greater than or equal to 2;
concatenating the F character vectors having the dimension of 1×M and M-F padding vectors having the dimension of 1×M based on F being less than M and
obtaining the first sentence representation vector having the dimension of M×M, wherein the values in the M-F padding vectors having the dimension of 1×M are 0.

13. The method according to claim 12, further comprising:
testing a to-be-tested target sentence recognition model based on the first sentence and the second sentence to obtain a target test result,
wherein the target test result indicates whether a same recognition result is obtained for the first sentence and the second sentence.

14. The method according to claim 13, wherein the testing a to-be-tested target sentence recognition model comprises:
inputting the first sentence into the target sentence recognition model to obtain a first sentiment label, wherein the first sentiment label indicates a sentiment type expressed by the semantics of the first sentence;
inputting the second sentence into the target sentence recognition model to obtain a second sentiment label, wherein the second sentiment label indicates a sentiment type expressed by the semantics of the second sentence;
determining whether the first sentiment label is the same as the second sentiment label;
determining, based on the first sentiment label being the same as the second sentiment label, that the target test result indicates that the same recognition result is recognized for the first sentence and the second sentence; and
determining, based on the first sentiment label being different from the second sentiment label, that the target test result indicates that different recognition results are obtained for the first sentence and the second sentence.

15. The method according to claim 14, further comprising:
generating prompt information based on the target test result indicating that different recognition results are recognized for the first sentence and the second sentence,
wherein the prompt information is configured to prompt adjustment of the target sentence recognition model.

16. A sentence generation system, comprising:
processing circuitry configured to:
encode a first sentence representation vector of a first sentence to obtain a first semantic representation vector and a perturbation weight vector,
the first sentence representation vector being determined based on a character vector of each respective character in the first sentence,
the first semantic representation vector indicating a plurality of semantics of the first sentence, and
the perturbation weight vector being configured to control a perturbation of the first semantic representation vector by a pre-determined perturbation vector;
perturb the first semantic representation vector, based on the perturbation weight vector and the perturbation vector, to obtain a second semantic representation vector; and
decode the second semantic representation vector to obtain a second sentence.

17. The system according to claim 16, wherein the processing circuitry is configured to:
sequentially pass the first sentence representation vector through N encoders having a same structure to obtain an N^{th} sentence encoded vector, N being a positive integer greater than or equal to 1;
perform first linear transformation on the N^{th} sentence encoded vector to obtain the first semantic representation vector; and
perform second linear transformation on the N^{th} sentence encoded vector to obtain the perturbation weight vector.

18. The system according to claim 17, wherein the processing circuitry is configured to sequentially pass the first sentence representation vector by:
inputting the first sentence representation vector into a first encoder in the N encoders to obtain the first sentence encoded vector; and
inputting the first sentence encoded vector into a second encoder in the N encoders to obtain a second sentence encoded vector.

19. The system according to claim 18, wherein the processing circuitry is configured to input the first sentence encoded vector by:
inputting the first sentence encoded vector into a self-attention module in the second encoder to obtain a second self-attention vector, the first sentence encoded vector and the second self-attention vector having a same dimension;
inputting the second self-attention vector and the first sentence encoded vector into a first summation and normalization module in the second encoder, wherein the inputting the second self-attention vector comprises:
performing summation on the second self-attention vector and the first sentence encoded vector to obtain a first summation vector, and
normalizing the first summation vector to obtain the second normalized vector, the first sentence encoded vector and the second normalized vector having a same dimension;
inputting the second normalized vector into a feedforward network module in the second encoder to obtain the second feedforward vector, the first sentence encoded vector and the second feedforward vector having a same dimension; and
inputting the second normalized vector and the second feedforward vector into a second summation and normalization module in the second encoder, wherein the inputting the second normalized vector comprises:
performing summation on the second normalized vector and the second feedforward vector to obtain a second summation vector, and
normalizing the second summation vector to obtain the second sentence encoded vector, the first sentence encoded vector and the second sentence encoded vector having a same dimension.

20. Anon-transitory computer-readable storage medium storing instructions which when executed by at least one processor cause the at least one processor to:
encode a first sentence representation vector of a first sentence to obtain a first semantic representation vector and a perturbation weight vector,
the first sentence representation vector being determined based on a character vector of each respective character in the first sentence,
the first semantic representation vector indicating a plurality of semantics of the first sentence, and
the perturbation weight vector being configured to control a perturbation of the first semantic representation vector by a pre-determined perturbation vector;
perturb the first semantic representation vector, based on the perturbation weight vector and the perturbation vector, to obtain a second semantic representation vector; and
decode the second semantic representation vector to obtain a second sentence.
